(19) United States
(12) Patent Application Publication
(10) Pub. No.: US 2014/0345799 A1
(43) Pub. Date: Nov. 27, 2014

(54) PRINTING METHOD FOR TOUCH PANEL DEVICE

(71) Applicant: HengHao Technology Co. LTD, Taoyuan County (TW)

(72) Inventors: Ting-Chieh Chen, Taoyuan County (TW); Chin-Liang Chen, Kaohsiung City (TW); Yung-Chih Liu, Taichung City (TW); CHEN-CHANG HSU, Taichung City (TW); CHUN-KAI CHANG, Taichung City (TW)

(73) Assignee: HengHao Technology Co. LTD, Taoyuan County (TW)

(21) Appl. No.: 14/205,009

(22) Filed: Mar. 11, 2014

(30) Foreign Application Priority Data
May 22, 2013 (TW) 102118020
Jul. 18, 2013 (TW) 102125681

(51) Int. Cl. G06F 3/041

(52) U.S. Cl. CPC G06F 3/041
USPC 156/277; 427/58; 427/108

(57) ABSTRACT

A printing method for a touch panel device is disclosed. The method includes the following steps: firstly, providing a substrate; then, printing a first shielding layer on a surface of the substrate; and afterwards, printing a second shielding layer on the first shielding layer, wherein the second shielding layer covers the first shielding layer, and a side surface of the second shielding layer is connected to the surface of the substrate.

### BACKGROUND OF THE INVENTION

1. Field of the Invention

The present invention generally relates to a printing method, and more particularly to a printing method for a shielding layer of a touch panel device.

2. Description of Related Art

A touch screen is an input/output device that utilizes sensing technology and display technology, and is widely used in electronic devices, particularly portable and handheld electronic devices.

A capacitor-based touch panel device is a commonly used touch panel device that utilizes capacitive coupling effect to detect touch position. Specifically, capacitance corresponding to the touch position changes and is thus detected, when a finger touches a surface of the touch panel device. Therefore, in the process of full-flat touch panel device, the process yield for adhering the cover glass becomes significant.

In the conventional process of the cover glass of the touch panel device 100, the pattern layer would be formed after the shielding layer is completed. Specifically, as shown in FIG. 1A, firstly the shielding layer 120 is formed on the cover class 110 by printing, wherein the first shielding layer 122 and the second shielding layer 124 are formed in order on the cover class 110, and the pattern layer 130 is then formed and colored in some certain colors, such that some parts of the pattern layer 130 would be exposed out of the shielding layer 120. Therefore, in the following adhering process, the pattern layer 130 would be easily scratched or damaged to decrease the product yield.

Moreover, referring to FIG. 1B, in the process of the shielding layer, it usually needs to form shielding layer 120 with a multi-layer structure, so as to have a better shielding effect. However, the shielding layer 120 is printed in the conventional process, as shown in FIG. 1B. A first shielding layer 122, second shielding layer 124, a third shielding layer 126 and a fourth shielding layer 128 are printed in order on an upper surface of the cover class 110, so that the side of the shielding layer 120 might have a stepped profile, which would increase the difficulty in the following process of being adhered to other element and decrease the product yield.

Referring to FIG. 1C, in the conventional adhering process of the touch panel device, the shielding layer 120 is generally printed on the cover class 110 firstly, and then the cover class 110 is proceeding to be adhered to a sensor element layer 140. However, as the size of the cover class is greater, the yield of cover class will be decreased sharply. Accordingly, if the scratch occurs on the surface of the cover class 110 in the process, the whole manufacturing cost would increase greatly.

For the reason that the conventional touch panel device requires a complex manufacturing process and cannot afford to make a thin touch panel device, a need has thus arisen to propose a novel touch electrode device to overcome disadvantages of the conventional touch panel devices.

### SUMMARY OF THE INVENTION

In view of the foregoing, it is an object of the embodiment of the present invention to provide a printing method for the touch panel device with the simplified manufacturing process, so as to improve the product yield and also decrease the manufacturing cost.

According to one embodiment of the present invention, a printing method for the touch panel device includes following steps: providing a substrate; printing a first shielding layer on a surface of the substrate; and printing a second shielding layer on the first shielding layer, wherein the second shielding layer covers the first shielding layer, and a side surface of the second shielding layer is connected to the surface of the substrate.

### BRIEF DESCRIPTION OF THE DRAWINGS

FIG. 1A shows a cross-sectional view of a conventional touch panel device;

FIG. 1B shows a cross-sectional view of another conventional touch panel device;

FIG. 1C shows a manufacturing process of a conventional touch panel device;

FIG. 2A-2D show manufacturing processes of the touch electrode device according to embodiments of the present invention; and

FIG. 3A-3C show manufacturing processes of the touch electrode device according to another embodiment of the present invention.

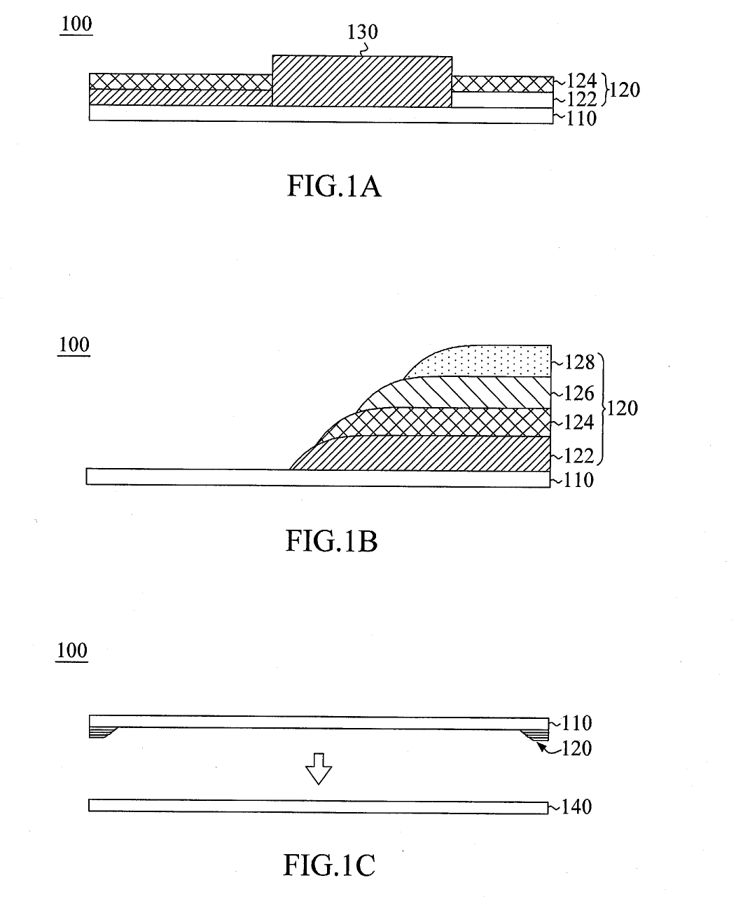

### DETAILED DESCRIPTION OF THE INVENTION

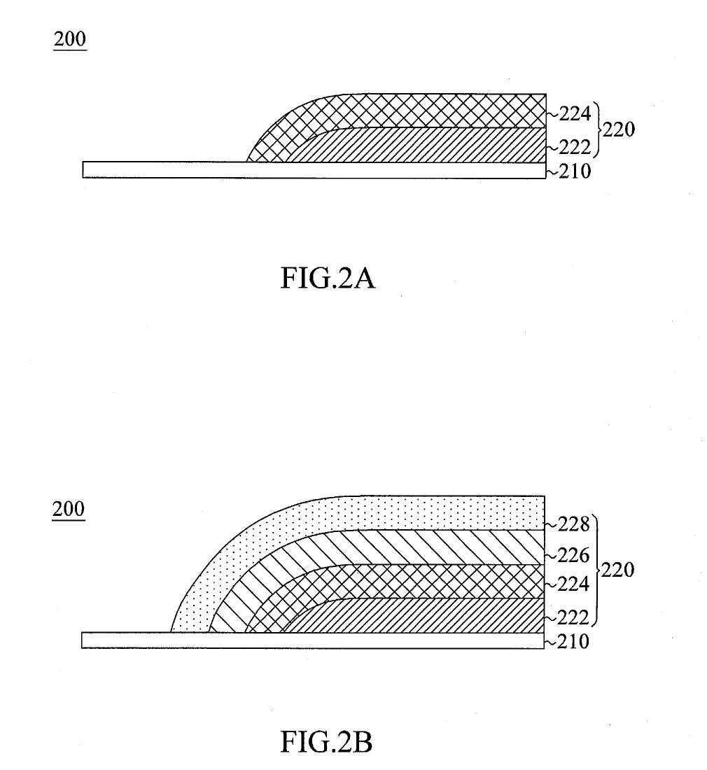

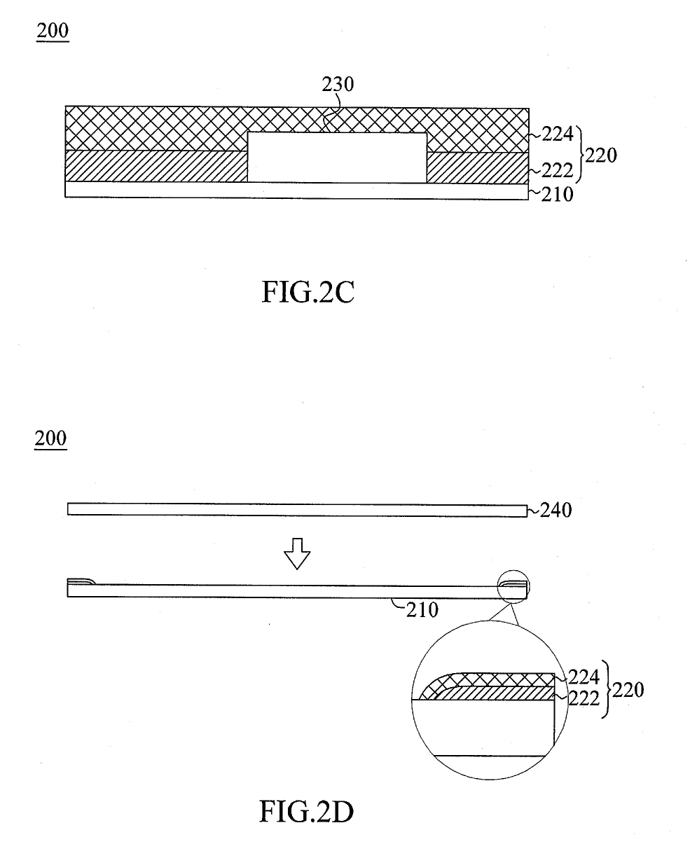

A printing method for a touch panel device is disclosed herein, and the method may be applied in a touch panel device to form a shielding layer 220, as shown in FIG. 2A. FIG. 2A illustrates the process of the printing method for the touch panel device according to an embodiment of the present invention. In the embodiment, the printing method includes the following steps: firstly, providing a substrate 210; then, printing a first shielding layer 222 on a surface of the substrate 210; and afterwards, printing a second shielding layer 224 on the first shielding layer 222. The second shielding layer 224 covers the first shielding layer 222, and a side surface of the second shielding layer 224 is connected to the surface of the substrate 210.

Practically, the shielding layer 220 is formed on the substrate 210 with multiple layer structure in which each layer is printed from a periphery section of the substrate 210 towards the center section of the substrate 210, so that the second shielding layer 224 may cover the first shielding layer 222. Consequently, the shielding layer 220 can have a smooth surface, so as to improve the surface smoothness of the shielding layer 220 and increase the yield of the following adhering process.

Furthermore, at least one of the first shielding layer 222 and the second shielding layer 224 may be an ink. In other words, the shielding layer 220 is formed on the substrate 210 by the ink printing method. Therefore, a high light shielding effect of the shielding layer 220 may be achieved by adjusting the number of the printing layers and the overall thickness of the shielding layer 220 according to the color or material of shielding layer 220. For instance, as shown in FIG. 2B, if the shielding layer 220 is formed of a light-color ink having a high transparency, the number of the printing layers of the shielding layer 220 should be increased, so that a first shielding layer 222, a second shielding layer 224, a third shielding layer 226 and a fourth shielding layer 228 are needed to be printed on the substrate in order to achieve the expected light shielding effect.

Moreover, referring to FIG. 2C, in another embodiment, after the first shielding layer 222 is printed on the substrate 210, a pattern layer 230 is then printed on the first shielding layer 222 and one surface of pattern layer 230 is adhered to the surface of the substrate 210. In the embodiment, the substrate 210 may be a cover class. Although the cover class in FIG. 2C is illustrated with a two-dimensional profile, the present invention is not limited thereto. Thus, the cover glass may have a two-dimensional or three-dimensional profile, which may be applied to a two-dimensional or a three-dimensional touch display, respectively. In one embodiment, the cover class may include a flexible material or a rigid material, and the surface material of the cover glass may be treated to have anti-wear, anti-scratch, anti-reflection, anti-glare and anti-fingerprint features. Moreover, the pattern layer 230 may include a letter, a number, a symbol, design or a combination thereof.

After the pattern layer 230 is formed, the second shielding layer 224 is printed in order to completely cover the first shielding layer 222 and the pattern layer 230 for providing a great anti-scratch protective mechanism. Therefore, the pattern layer 220 may be smoothly adhered to other sensor layers or isolation layers, and the pattern layer 230 will not be scratched or crashed, so as to improve the product yield.

Referring to FIG. 20, in another embodiment, the substrate 210a may be a flexible board or a transparent substrate, and the substrate 210 may include at least one sensor electrode element. Furthermore, the substrate 210 may also include an isolating material or a photosensitive material. However, after the shielding layer 220 is formed on the substrate 210 with a multiple layer structure, a cover class 240 is then adhered to the shielding layer 220. Particularly, as shown in FIG. 2D, a top surface of the second shielding layer 224 is adhered to the surface of the cover class 240. Moreover, in this embodiment, the cover class 240 may have a two-dimensional or three-dimensional profile, which may be applied to a two-dimensional or a three-dimensional touch display respectively, and the cover class 240 may also include a flexible material or a rigid material.

Consequently, as the shielding layer 220 is printed on an electrode layer, an isolating layer or a transparent layer, before being adhered to the cover class 240, the cover class 240 may avoid the damage by crashes or scratches in the manufacturing process, so as to greatly reduce material and manufacturing cost.

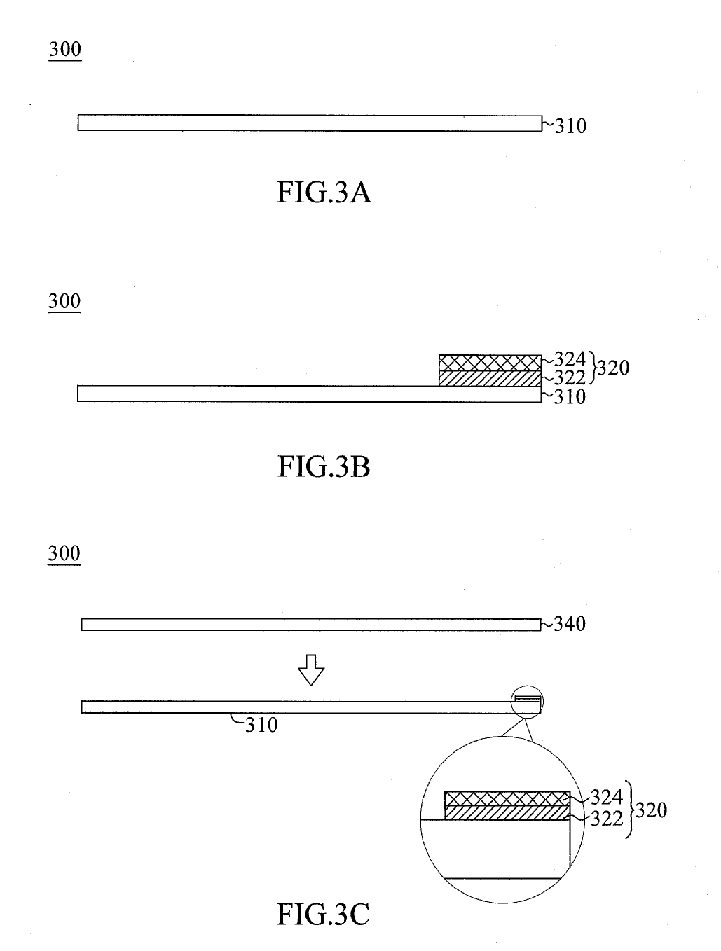

The present invention also discloses another printing method for a touch panel device. The method may be applied in a touch panel device 300 in order to form a plurality of shielding layers 320. FIG. 3A to FIG. 3C illustrate the steps of the method according to another embodiment of the present invention.

Referring to FIG. 3A, firstly, a substrate 310 is provided. The substrate 310 may be a flexible board or a transparent substrate. The substrate 310 may include at least one sensor electrode element. In one embodiment, the substrate 310 may include an isolating material or a photosensitive material.

Then, referring to FIG. 3B, a plurality of shielding layer 320 are printed on a surface of the substrate 310. As shown in FIG. 3B, a first shielding layer 322 and a second shielding layer 324 are printed on the substrate 310 in order, and at least one of the first shielding layer 322 and the second shielding layer 324 is an ink. Although, the first shielding layer 322 and the second shielding layer 324 in FIG. 3B are illustrated to be aligned with each other on the substrate 310, however the printing method and the structure of the shielding layers 320 of the present invention is not limited thereto. The first shielding layer 322 and the second shielding layer 324 may be formed in such a manner that the upper layer entirely covers the lower layer, or the upper layer only covers the main part of the lower layer and the rear of the lower layer is exposed as mentioned above, according to the practical requirements. Furthermore, in FIG. 3B the shielding layer 320 is illustrated to have a double-layer structure with the first shielding layer 322 and the second shielding layer 324, but the shielding layer 320 is not limited thereto. The number of layers may be adjusted according to the process requirement or actual condition.

Referring to FIG. 3C, a cover class 340 is adhered to the shielding layer 320. The cover class 340 includes a flexible material or a rigid material, and the surface material of the cover glass 340 may be treated to have anti-wear, anti-scratch, anti-reflection, anti-glare and anti-fingerprint features. Moreover, the cover glass 340 may have a two-dimensional or three-dimensional profile, which may be applied to a two-dimensional or a three-dimensional touch display, respectively.

Although specific embodiments have been illustrated and described, it will be appreciated by those skilled in the art that various modifications may be made without departing from the scope of the present invention, which is intended to be limited solely by the appended claims.

What is claimed is:

1. A printing method for a touch panel device, comprising the steps of:
providing a substrate;
printing a first shielding layer on a surface of the substrate;
printing a second shielding layer on the first shielding layer, wherein the second shielding layer covers the first shielding layer, and a side surface of the second shielding layer is connected to the surface of the substrate.

2. The printing method of claim 1, wherein each of the first shielding layer and the second shielding layer is an ink.

3. The printing method of claim 1, wherein the step of printing the first shielding layer on the surface of the substrate, further comprising:
printing a pattern layer in the first shielding layer, wherein the pattern layer is adhered to the surface of the substrate.

4. The printing method of claim 3, wherein the pattern layer comprises a letter, a number, a symbol, a design or a combination thereof.

5. The printing method of claim 3, wherein the substrate is a cover class.

6. The printing method of claim 5, wherein the cover class comprises a flexible material or a rigid material.

7. The printing method of claim 1, wherein the substrate is a flexible board or a transparent substrate.

8. The printing method of claim 7, wherein the substrate comprises at least one sensor electrode element.

9. The printing method of claim 7, wherein the substrate comprises an isolating material or a photosensitive material.

10. The printing method of claim 7, further comprising:
adhering a cover class to the shielding layer, wherein a top surface of the second shielding layer is adhered to a surface of the cover class.

11. The printing method of claim 10, wherein the cover class comprises a flexible material or a rigid material.

12. A printing method for a touch panel device, comprising:
providing a substrate;
printing a plurality of shielding layers on a surface of the substrate; and
adhering a cover class to the shielding layers.

13. The printing method of claim 12, wherein the substrate is a flexible board or a transparent substrate.

14. The printing method of claim 13, wherein the substrate comprises at least one sensor electrode element.

15. The printing method of claim 13, wherein the substrate comprises an isolating material or a photosensitive material.

16. The printing method of claim 12, wherein at least one of the shielding layers is an ink.

17. The printing method of claim 12, wherein the cover class comprises a flexible material or a rigid material.
